(19) United States
(12) Patent Application Publication
(10) Pub. No.: US 2016/0124882 A1
(43) Pub. Date: May 5, 2016

(54) Electronic Device, System, and Operation-Mode Selection Program

(71) Applicant: Alpine Electronics, Inc., Tokyo (JP)

(72) Inventor: Tsutomu Suetsugu, Iwaki (JP)

(21) Appl. No.: 14/885,505

(22) Filed: Oct. 16, 2015

(30) Foreign Application Priority Data
Oct. 29, 2014 (JP) 2014-220133

(51) Int. Cl. G06F 13/38; G06F 9/44

(52) U.S. Cl. CPC G06F 13/385; G06F 9/4411; G06F 9/4406

(57) ABSTRACT

A vehicle-mounted electronic system includes a vehicle-mounted device and a mobile terminal connected to the vehicle-mounted device through a connection unit. The vehicle-mounted device includes a request unit configured to request the mobile terminal to provide start-up notification for an application stared in the mobile terminal, a reception unit configured to receive the start-up notification through the connection unit, and a control unit configured to control selection of an operation mode such that the operation mode corresponding to the application identified by the start-up notification is selected.

### RELATED APPLICATIONS

The present application claims priority to Japanese Patent Application Serial Number 2014-220133, filed Oct. 29, 2014, the entirety of which is hereby incorporated by reference.

### BACKGROUND OF THE INVENTION

1. Field of the Invention

The present disclosure relates to electronic devices connectable to multifunctional mobile terminals, typified by smartphones, and in particular, to selection of an operation mode in an electronic device connected to a multifunctional mobile terminal.

2. Description of the Related Art

Multifunctional mobile terminals (hereinafter referred to as mobile terminals), typified by smartphones, have been increasingly used in recent years. When such a mobile terminal is carried into a vehicle, it can be connected to an electronic device mounted on the vehicle (hereinafter referred to as vehicle-mounted device) and media data obtained in the mobile device or media data played in the mobile terminal can be output from the vehicle-mounted device. That is, both of the mobile terminal and the vehicle-mounted device have connection interfaces for USB connection, near field communication, or other standards and are configured to allow an application in the mobile terminal to be used in the vehicle-mounted device.

Japanese Unexamined Patent Application Publication No. 2012-208891 discloses an information system configured to transmit a command to a mobile information terminal that is to execute an application and configured to receive image data and sound data of the application executed in accordance with the command. Japanese Unexamined Patent Application Publication No. 2014-94624 discloses a vehicle display device that controls an application in a mobile terminal detachable from a vehicle on-board unit fixed on a vehicle such that the application is started at the time when the mobile terminal is set in the vehicle on-board unit.

When an application in the mobile terminal is started in the vehicle-mounted device, audio data or video data obtained by the application executed in the mobile terminal is transmitted to the vehicle-mounted device. The vehicle-mounted device outputs the received audio data or video data.

Icons for starting up applications stored in the mobile terminal are displayed on the screen in the mobile terminal, whereas icons for starting up applications in the mobile terminal are displayed on the screen in the vehicle-mounted device. That is, common icons for running the same applications are displayed on the mobile terminal and the vehicle-mounted device. For example, to start up an application P in the mobile terminal, a user can start it up by operating either one of the icon in the mobile terminal and the icon in the vehicle-mounted device.

However, when the mobile terminal is connected to the vehicle-mounted device, the vehicle-mounted device is in the state where it can output audio data or video data transmitted from the mobile terminal. Thus to execute the application P, the user needs to operate the icon in the vehicle-mounted device and start up the application P. In this case, the operation mode for the application P is selected in the vehicle-mounted device. Then a signal for starting up the application P is transmitted from the vehicle-mounted device to the mobile terminal. The mobile terminal executes the application P in response to that start-up signal and transmits audio data or video data obtained by the execution of the application P to the vehicle-mounted device. The vehicle-mounted device outputs the received audio data or video data.

In the state where the mobile terminal and the vehicle-mounted device are connected, the restriction that the user must operate the vehicle-mounted device to start up the application P is imposed. In particular, when the user having the mobile terminal connected to the vehicle-mounted device is in a rear seat, although the mobile terminal is in his or her hand, he or she needs to ask a user in a front seat to perform an input operation, thereby decreasing the operability.

### SUMMARY OF THE INVENTION

The present disclosure is made to address the above known problem. It is an object of the present disclosure to provide an electronic device, system, operation-mode selection program, and operation-mode selection method that facilitate selecting an operation mode when the electronic device is connected to an external device.

In one form of the present disclosure, an electronic device may include a connection unit, a selection unit, an output unit, a request unit, a reception unit, and a control unit. The connection unit is configured to enable connection between the electronic device and an external device that stores one or more applications. The selection unit is configured to select at least one operation mode from among a plurality of operation modes. The output unit is configured to output information on the basis of the operation mode selected by the selection unit. The request unit is configured to request the external device to provide start-up notification for an application started in the external device, in response to connection by the connection unit. The reception unit is configured to receive the start-up notification through the connection unit. The control unit is configured to control the selection unit so as to select an operation mode corresponding to the application identified by the start-up notification.

The control unit may include a determination unit configured to determine whether switching of the operation mode is feasible; when the determination unit determines that the switching is feasible, the control unit may cause the selection unit to change the operation mode; and when the determination unit determines that the switching is unfeasible, the control unit may not cause the selection unit to change the operation mode. The selection unit may include an input screen on which the plurality of operation modes are selectable, and one or more icons for starting up one or more applications stored in the external device may be displayed on the input screen, and when an icon on the input screen is selected by a user, the selection unit may be able to select the operation mode corresponding to the application associated with the icon.

The control unit may receive the start-up notification, the control unit may cause the selection unit to automatically select the icon corresponding to the application identified by the start-up notification. The request unit may provide the external device with identification information for the applications associated with the icons displayed on the input screen.

The electronic device may further include a unit configured to receive closing information indicating closing of the application started in the external device, and the control unit may control the selection unit so as to select a last operation mode. When the output unit outputs emergency information or interruption information, the determination unit may determine that the switching of the operation mode is unfeasible. When the determination unit determines that the switching of the operation mode is unfeasible, the control unit may display a user input screen that prompts a user to determine whether the operation mode is to be switched. The output unit may receive video data or audio data created by the application started in the external device through the connection unit and outputs the received video data or the audio data. The electronic device may be mounted on a movable vehicle, and the external device may be a mobile terminal connected to the electronic device in the vehicle.

In another form of the present disclosure, a system may include the electronic device having the above configuration and an external device connected to the electronic device through the connection unit. The external device includes a storage unit configured to store one or more applications, a user input unit, an execution unit configured to execute an application in response to an instruction to start up the application received through the user input unit, and a start-up notification providing unit configured to provide start-up notification for the application started by the execution unit in response to the request from the request unit.

The external device may further include a display unit configured to display one or more icons for starting up the one or more applications, and at least one icon displayed on the input screen in the electronic device may be identical with at least one of the icons displayed by the display unit. The external device may further include a transmission unit configured to transmit audio data or video data obtained by the execution of the application to the electronic device through the connection unit when the execution unit executes the application, and the output unit in the electronic device may output the audio data or video data received through the connection unit. The external device may further provide the electronic device with closing information indicating closing of the started application when the started application is closed.

In another form of the present disclosure, an operation-mode selection program is executable by an electronic device connectable to an external device that stores one or more applications. The operation-mode selection program includes a step of detecting connection to the external device, a step of requesting the external device to provide start-up notification for an application started in the external device, a step of selecting an operation mode corresponding to an application identified by the received start-up notification, and a step of executing the selected operation mode.

In yet another form of the present disclosure, an operation-mode selection method for use in an electronic device connectable to an external device that stores one or more applications. The operation-mode selection method includes a step of detecting connection to the external device, a step of requesting the external device to provide start-up notification for an application started in the external device, a step of selecting an operation mode corresponding to an application identified by the received start-up notification, and a step of executing the selected operation mode.

In forms of the present disclosure, an electronic device connected to an external device can receive a start-up notification of an application started in the external device and cause an operation mode corresponding to the application to be selected on the basis of the received start-up notification. Accordingly, a user can start up the application in the external device and does not have to perform an operation for selecting the operation mode in the electronic device. This can enhance usability.

### BRIEF DESCRIPTION OF THE DRAWINGS

FIG. 1 illustrates an example of a vehicle-mounted electronic system;

FIG. 2 illustrates an example configuration of a vehicle-mounted device;

FIG. 3 is a block diagram that illustrates a functional configuration of an operation-mode selection program installed in the vehicle-mounted device;

FIG. 4 illustrates an example configuration of a mobile terminal;

FIG. 5 is a block diagram that illustrates a functional configuration of an operation-mode selection program installed in the mobile terminal;

FIG. 6 is a flowchart that describes an operation of selecting the operation mode;

FIGS. 7A and 7B illustrate audio selecting screens on the vehicle-mounted device and screens on which icons are displayed in the mobile terminal;

FIG. 8 is a flowchart that describes a concrete operational example in the operation mode illustrated in FIG. 7B; and

FIG. 9 is a flowchart that describes an operation of selecting the operation mode.

### DETAILED DESCRIPTION OF THE DRAWINGS

Forms of the present disclosure are described below with reference to the drawings. In forms of the present disclosure, an electronic device is mounted on a movable vehicle or the like. The functions in the electronic device are not limited and can include the television and radio receiving functions and the communication function. Examples of an external device connected to the electronic device may include a cellular phone, smartphone, and tablet terminal. The embodiments and forms described below illustrate example systems in which a vehicle-mounted device and a mobile terminal are connected.

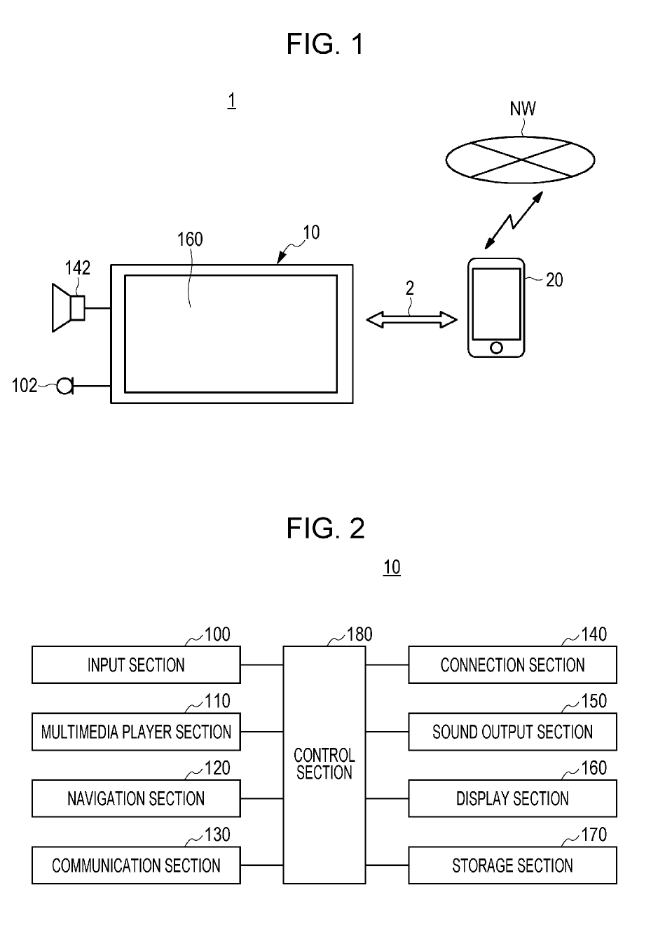

FIG. 1 illustrates an example configuration of a vehicle-mounted electronic system that includes a vehicle-mounted device and a mobile terminal connected to the vehicle-mounted device. In this system 1, when a mobile terminal 20 is carried in a vehicle, the mobile terminal 20 can be connected to a vehicle-mounted device 10 by a connection unit 2. The connection unit 2 may achieve connection in a wireless or wired manner. The connection unit 2 may achieve connection by WiFi (registered trademark), Bluetooth (registered trademark), or universal serial bus (USB). The connection unit 2 enables bidirectional data exchange between the vehicle-mounted device 10 and the mobile terminal 20. The data includes audio data, video data, and control data. When the mobile terminal 20 is connected to the vehicle-mounted device 10, the mobile terminal 20 and the vehicle-mounted device 10 can operate in cooperation with each other. For example, the vehicle-mounted device 10 can behave as if it functions as input and output equipment for the mobile terminal 20, thus allowing resources in the mobile terminal 20 to be output from a sound system in the vehicle-mounted device. The resources in the mobile terminal 20 include not only data and applications stored in the mobile terminal but also data obtained in communications over an external network NW.

The vehicle-mounted device 10 has the function of playing audio data and video data and includes a display section 160 configured to display video data being played, a speaker 142 configured to output audio data, and a microphone 102 configured to receive voice instructions from a user. The speaker 142 may be an in-vehicle speaker, and the microphone 102 may be an in-vehicle microphone. They may be a headphone set connected to the vehicle-mounted device 10 in a wireless or wired manner.

The mobile terminal 20 may typically be a smartphone. The mobile terminal 20 can have the telephone function using a public telephone network and the data communication function of exchanging data with various servers over the network NW and can also have the handsfree function of, for example, enabling voice communications through the vehicle-mounted device 10 or a headphone set.

FIG. 2 is a block diagram that illustrates a detailed example of a configuration of the vehicle-mounted device. The vehicle-mounted device 10 includes an input section 100, a multimedia player section 110, a navigation section 120, a communication section 130, a connection section 140, a sound output section 150, the display section 160, a storage section 170, and a control section 180. This configuration is one example.

The input section 100 receives an instruction from a user using input key equipment, a voice input recognition device, a touch screen, or other similar device and provides it to the control section 180. The multimedia player section 110 reads video data, audio data, or other similar data stored in a storage medium, such as a digital versatile disc (DVD), compact disc (CD), or Blu-ray disc and plays it. The multimedia player section 110 has the television receiving function and the radio receiving function and plays received video data or audio data. The navigation section 120 can cause a road map around a present vehicle location to be displayed and can search and guide a route to a destination on the basis of positional information transmitted from a global positioning system (GPS) satellite or positional information obtained from various sensors, such as a gyro-sensor or an acceleration sensor. The communication section 130 enables data communications with an external network or the like.

The connection section 140 enables the vehicle-mounted device 10 to be connected to an external device. The connection section 140 enables bidirectional data exchange between the vehicle-mounted device 10 and the external device in a wireless or wired manner. The connection section 140 corresponds to the connection unit 2 connecting the vehicle-mounted device 10 and the mobile terminal 20 illustrated in FIG. 1. The sound output section 150 outputs audio data created by the multimedia player section 110 or navigation section 120 through the speaker 142. The display section 160 displays video data created by the multimedia player section 110 or navigation section 120 on a display.

The storage section 170 can store application software executable by the vehicle-mounted device, programs executable by the control section 180, and other necessary data. For example, the storage section 170 can store a database for road data and facility data required by the navigation section 120. The control section 180 includes a microprocessor and microcontroller and controls the sections by executing a program or the like stored in a read-only memory (ROM) or random-access memory (RAM) or the storage section 170.

Preferably, when the mobile terminal 20 is connected to the vehicle-mounted device 10, the control section 180 executes cooperation mode in which the vehicle-mounted device 10 and the mobile terminal 20 can operate in cooperation with each other, thereby controlling the functions of the sections. In the cooperation mode, the vehicle-mounted device 10 can behave as if it functions as the input and output equipment for the mobile terminal 20. In this state, audio data or video data created by the mobile terminal 20 is output from the vehicle-mounted device 10. The cooperation mode in this form includes an operation-mode selection program for performing control such that an operation mode selected in the mobile terminal is enabled in the vehicle-mounted device.

Here, the operation mode is a selection of a function in the vehicle-mounted device, and examples may include an audio operation, video operation, navigation operation, and output operation in the mobile terminal. The operation mode may further include identification of a source at a lower level than the above operations. For example, for the audio operation, identification of a DVD, CD, Blu-ray disc, or radio broadcasting may be included. The operation mode may further include identification of a specific content of the source, in addition to the above source identification. For example, in radio broadcasting in audio operation, identification of a specific broadcasting station or emergency broadcasting may be included.

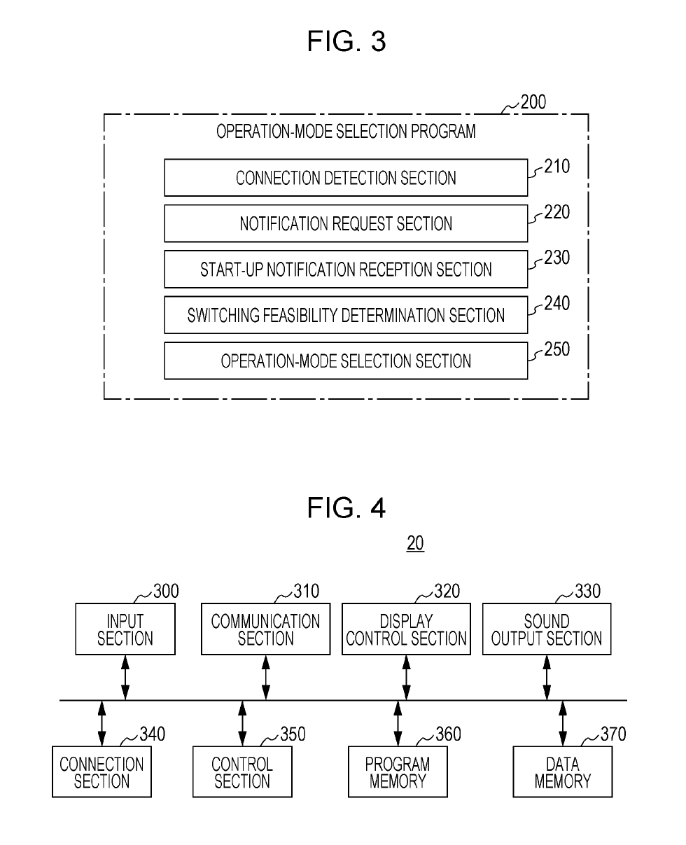

FIG. 3 illustrates an example configuration of the operation-mode selection program. An operation-mode selection program 200 includes a connection detection section 210, a notification request section 220, a start-up notification reception section 230, a switching feasibility determination section 240, and an operation-mode selection section 250, as illustrated in FIG. 3.

The connection detection section 210 detects whether the mobile terminal 20 is connected to the vehicle-mounted device 10 through the connection section 140. The connection form may be a connection in a wireless or wired manner. In response to the detection of the connection by the connection detection section 210, the notification request section 220 requests the mobile terminal 20 to provide start-up notification when a predetermined application is started in the mobile terminal to notify the start-up. The start-up notification reception section 230 receives the start-up notification transmitted from the mobile terminal 20 in response to the request from the notification request section 220 and supplies it to the switching feasibility determination section 240.

The switching feasibility determination section 240 determines whether the currently selected operation mode in the vehicle-mounted device 10 can be changed to another operation mode. The operation-mode selection section 250 selects the operation mode on the basis of the determination by the switching feasibility determination section 240. That is, when the switching feasibility determination section 240 determines that the switching of the operation mode is “feasible,” the operation-mode selection section 250 switches the current operation mode in the vehicle-mounted device such that an operation mode selected in the mobile terminal is enabled. When the switching feasibility determination section 240 determines that the switching of the operation mode is “unfeasible,” the operation-mode selection section 250 does not switch the currently selected operation mode in the vehicle-mounted device.

FIG. 4 is a block diagram that illustrates an example configuration of the mobile terminal 20. The mobile terminal 20 includes an input section 300 configured to receive an input from a user; a communication section 310 configured to enable communications over a public telephone network or through network communications; a display control section 320 configured to control displaying on the display; a sound output section 330 configured to control outputting of sound from the speaker; a connection section 340 configured to establish connection to an electronic apparatus, such as the vehicle-mounted device 10, by the connection unit 2; a control section 350 including a microcontroller and microprocessor and configured to control the sections by executing a program; a program memory 360 storing application software for performing the functions, such as audio playing, radio playing, and navigation, and a program for supporting the cooperation mode for cooperation with the vehicle-mounted device 10; and a data memory 370 storing various kinds of data.

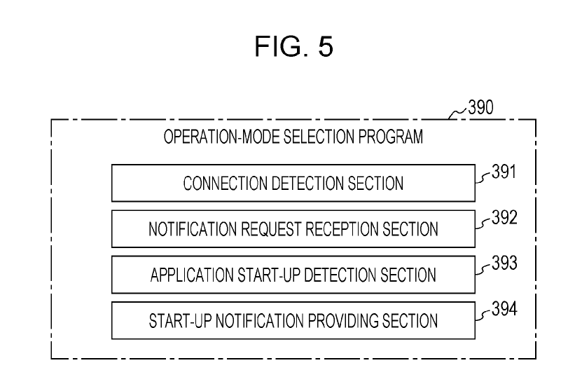

FIG. 5 is a block diagram that illustrates a functional configuration of an operation-mode selection program installed in the mobile terminal. As illustrated in FIG. 5, an operation-mode selection program 390 includes a connection detection section 391, a notification request reception section 392, an application start-up detection section 393, and a start-up notification providing section 394. The connection detection section 391 is configured to detect whether the mobile terminal 20 is connected to the vehicle-mounted device 10 through the connection section 340. The notification request reception section 392 is configured to receive a notification request from the notification request section 220 in the vehicle-mounted device 10 and inform the application start-up detection section 393 of the reception. The application start-up detection section 393 is configured to detect whether an application is started through the input section 300 in the mobile terminal.

Icons corresponding to applications stored in the mobile terminal are displayed on the display in the mobile terminal. The user can start up any application by touching or the like. Preferably, the application start-up detection section 393 detects starting-up of an application that allows cooperation with the vehicle-mounted device 10 and does not detect starting-up of an application irrelevant to the cooperation. The identification of the application that allows the cooperation or that of the application irrelevant to the cooperation may be preset in the mobile terminal. The application that allows the cooperation may be identified on the basis of application identifying information for identifying the application transmitted from the vehicle-mounted device 10.

The start-up notification providing section 394 provides the vehicle-mounted device 10 with start-up notification for the started application in response to the detection by the application start-up detection section 393. The start-up notification includes at least application identifying information for identifying the application.

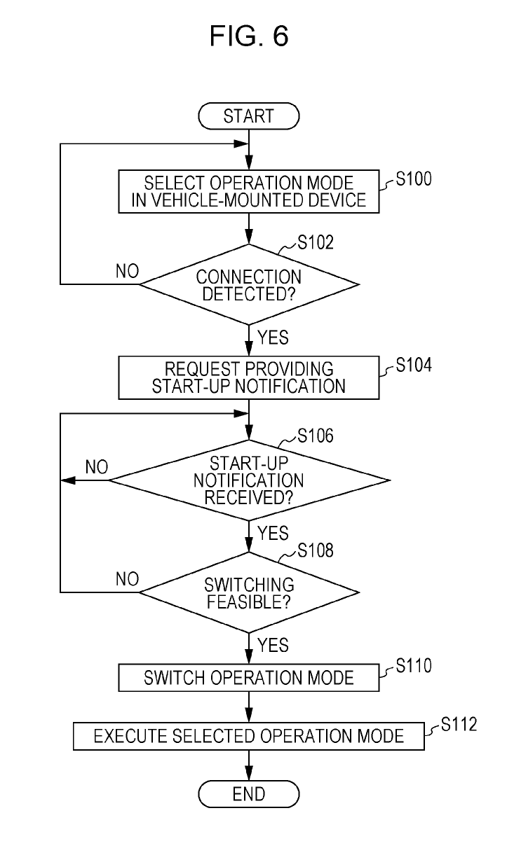

Next, operations in the vehicle-mounted electronic system are described. FIG. 6 illustrates an operation-mode selection process in the vehicle-mounted device. Here, as an example, a state where an operation mode is selected in the vehicle-mounted device 10 is illustrated (S100). When the mobile terminal 20 is connected to the vehicle-mounted device 10, the connection is detected by the connection detection section 210 (S102). When the connection to the mobile terminal 20 is detected by the connection detection section 210, the notification request section 220 requests the mobile terminal 20 to provide start-up notification for an application (S104). At this time, the notification request section 220 can request providing start-up notification for a specific application. In this case, identification information for a desired application is provided together with the request. In some implementations, as described below, it is required to provide start-up notification for an application associated with an icon displayed on a menu screen in the vehicle-mounted device 10.

The start-up notification reception section 230 monitors reception of start-up notification from the mobile terminal 20 (S106). When the start-up notification is received, then the switching feasibility determination section 240 determines whether the currently selected operation mode can be switched to an operation mode corresponding to the application started in the mobile terminal (S108). The criteria for determining whether the switching is feasible is preset, and the determination is made in accordance with the criteria. Example cases where the switching is unfeasible may include a case where emergency broadcasting or interrupt broadcasting is output in the currently selected operation mode (e.g., radio broadcasting) and a case where an operation mode corresponding to the started application is not in a standby state (e.g., power is not supplied). The conditions that the switching is feasible or not may be set by the user.

The determination by the switching feasibility determination section 240 is supplied to the operation-mode selection section 250. When it is determined that the switching is feasible, the operation-mode selection section 250 switches the current operation mode to the operation mode corresponding to the application started in the mobile terminal such that the started application is enabled (S110). In response to this, the sound output section 150 and/or the display section 160 executes the selected operation mode (S112).

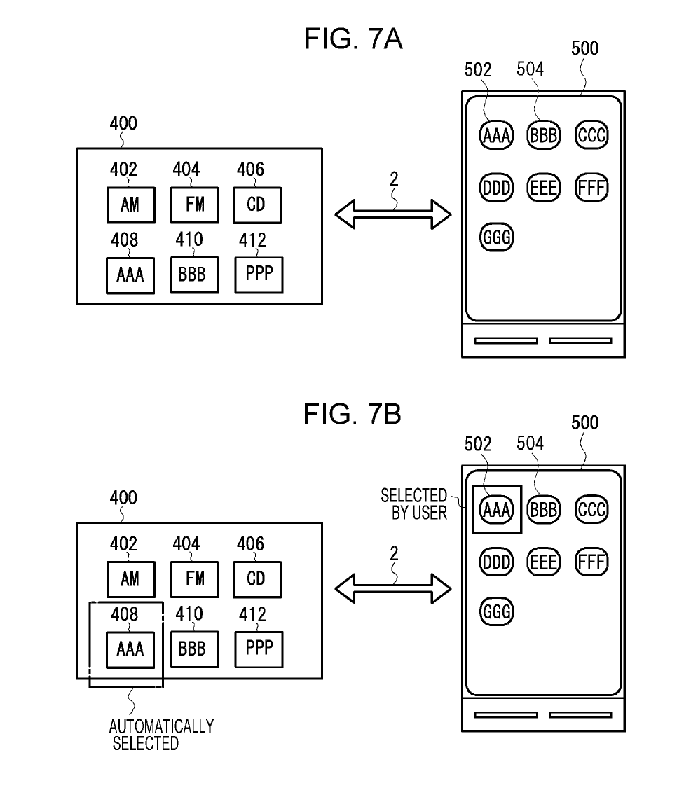

Next, a concrete operation example is described. FIG. 7A illustrates an example of screens in the displays in both devices when the mobile terminal 20 is connected to the vehicle-mounted device 10. First, an audio selecting screen 400 for selecting an audio operation is displayed in the display section 160 in the vehicle-mounted device 10. Icons for selecting sources are displayed on the audio selecting screen 400. An icon 402 is used for selecting/starting an AM broadcast. An icon 404 is used for selecting/starting an FM broadcast. An icon 406 is used for selecting/starting a CD. An icon 408 is used for selecting/starting up an application AAA. An icon 410 is used for selecting/starting up an application BBB. An icon 412 is used for selecting/starting up an application PPP. The icons 402 to 406 are used for performing the functions in the vehicle-mounted device 10. The icons 408 to 412 are used for executing the applications stored in the mobile terminal 20 connected to the vehicle-mounted device 10.

Icons for starting up various applications stored in the mobile terminal are displayed on a screen 500 in the mobile terminal 20. Of the icons, an icon 502 is used for executing the application AAA. An icon 504 is used for executing the application BBB.

A typical traditional operation occurring when the mobile terminal 20 is connected to the vehicle-mounted device 10 by the connection unit 2 is described below. In the traditional operation, a user can select an icon on the audio selecting screen 400 to begin a desired operation. For example, the user can receive an AM broadcast by selecting the icon 402 and can listen a CD by selecting the icon 406. When the user selects the icon 408, identification information for the application AAA associated with the icon 408 is transmitted to the mobile terminal 20 through the connection unit 2, the mobile terminal 20 executes the application AAA, audio data/video data created by the execution of the application AAA is transmitted to the vehicle-mounted device 10 through the connection unit 2, and the audio data/video data is output from the vehicle-mounted device.

To select an operation mode (icon) on the audio selecting screen 400 and then switch to another operation mode, the user must select a desired icon on the audio selecting screen 400. One example case where the user receiving a radio broadcast wants to switch an Internet radio broadcast airing the same content as in the radio broadcast is discussed. If the application AAA is the application for receiving the Internet radio broadcast, the user can select the icon 408 on the audio selecting screen 400 in the vehicle-mounted device. That is, although the icon 502, which is the icon for selecting the application AAA and is common to the icon 408, is displayed in the mobile terminal 20, the operation mode cannot be selected in the mobile terminal.

In contrast to this traditional example, in forms of the present disclosure, selecting the icon 502 in the mobile terminal 20 can cause the operation mode to be automatically switched as if the icon 408 were selected on the audio selecting screen in the vehicle-mounted device. This concept is illustrated in FIG. 7B.

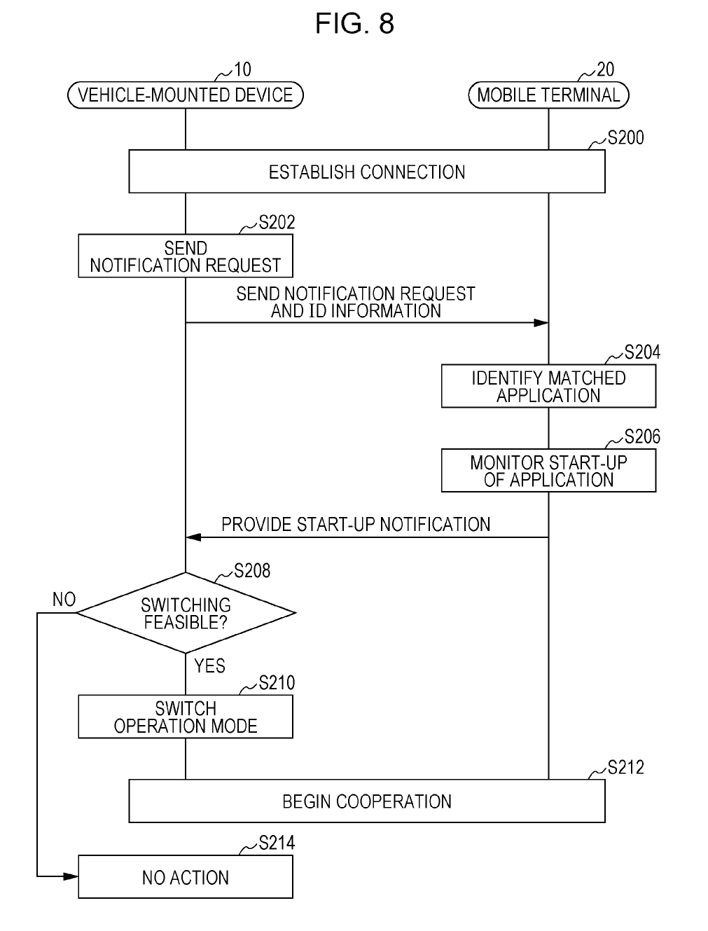

FIG. 8 is a flowchart for describing selection of the operation mode illustrated in FIG. 7B. First, the vehicle-mounted device 10 and the mobile terminal 20 are connected by the connection unit 2 (S200). When the connection is detected, the notification request section 220 requests the mobile terminal 20 to provide start-up notification for an application (S202). The notification request includes identification information for the applications associated with the icons displayed on the audio selecting screen 400 in the vehicle-mounted device. In this example, the icons 408, 410, and 412 associated with the applications are displayed on the audio selecting screen 400, and the identification (ID) information corresponding to the applications AAA, BBB, and PPP is provided. The icons 408, 410, and 412 may be registered in the vehicle-mounted device 10 from the beginning, and they may also be registered by a user afterward.

The notification request reception section 392 in the mobile terminal receives the notification request and the identification information, compares the applications stored in the mobile terminal with the applications that can be started in the vehicle-mounted device, and identifies a matched application (S204). In this example, the applications AAA and BBB are matched, and the application PPP is not matched because it is not stored in the mobile terminal.

Then, the application start-up detection section 393 monitors whether a matched application is started in the mobile terminal (S206). That is, the application start-up detection section 393 monitors whether the icon 502 or 504 on the screen 500 in the mobile terminal is selected by a user. When the icon 502 or 504 is selected by the user, the application start-up detection section 393 transmits start-up notification including notification of the start-up and the identification information for the started application to the vehicle-mounted device 10.

When the switching feasibility determination section 240 in the vehicle-mounted device receives the start-up notification, it determines whether switching of the operation mode is feasible (S208). When it is determined that the switching is feasible, the operation-mode selection section 250 switches the operation mode (S210), and cooperation between the vehicle-mounted device 10 and the mobile terminal 20 begins (S212). When it is determined that the switching is unfeasible, the operation-mode selection section 250 does not switch the operation mode (S214). For example, when the user receiving an AM radio broadcast selects the icon 502 in the mobile terminal 20 to switch the operation mode to an Internet radio broadcast, audio data obtained by the application for the Internet radio broadcast started in the mobile terminal 20 is transmitted to the vehicle-mounted device 10. At this time, because the operation mode in the vehicle-mounted device 10 is automatically switched as if the icon 408 were selected, the vehicle-mounted device 10 can output sound of the audio data received from the mobile terminal.

In the implementations described above, identification information for specific applications (applications AAA, BBB, and PPP in FIGS. 7A and 7B) is transmitted from the vehicle-mounted device 10 to the mobile terminal 20. The transmission of the identification information is optional. When no application identification information is transmitted from the vehicle-mounted device 10, the mobile terminal 20 may transmit start-up notification for each of all applications started in the mobile terminal 20 to the vehicle-mounted device 10, the vehicle-mounted device may determine whether the started application can be remotely operated, and if it is so, the operation mode may be switched.

In the implementations described above, when the switching feasibility determination section 240 determines that the switching of the operation mode is unfeasible, the operation mode is not switched. In that case, final determination whether the operation mode is to be switched may be carried out by the user. For example, when it is determined that the switching of the operation mode is unfeasible, an input button that prompts the user to determine whether the operation mode is to be switched or not may be displayed in the display section 160, and the state may wait for an input from the user.

Next, additional forms of the present disclosure are described. In these forms, when the vehicle-mounted device 10 receives closing information indicating that an application is closed from the mobile terminal 20, the operation mode is returned to the last operation mode. The additional forms have a similar configuration to that in the implementations described above, and the operation-mode selection program 390 in the mobile terminal 20 further includes an application closing detection section configured to detect closing of an application and a closing-information providing section configured to provide closing information when the application closing detection section detects closing of an application. For example, the application closing detection section can detect an instruction to close an application input from a user or can detect the time of closing of an application if the application is automatically closed after a predetermined sequence. When the operation-mode selection section 250 in the vehicle-mounted device receives application closing information, it returns the operation mode to the last operation mode. For example, when an application for an Internet radio is started in the mobile terminal, the operation mode in the vehicle-mounted device is switched from the radio broadcast to the Internet radio broadcast. When the application for the Internet radio broadcast is closed in the mobile terminal, the operation mode in the vehicle-mounted device is switched from the Internet radio broadcast to the radio broadcast.

In these implementations of the present disclosure, switching of the operation mode in the vehicle-mounted device can be automatically controlled in synchronization with the start-up and closing of an application in the mobile terminal.

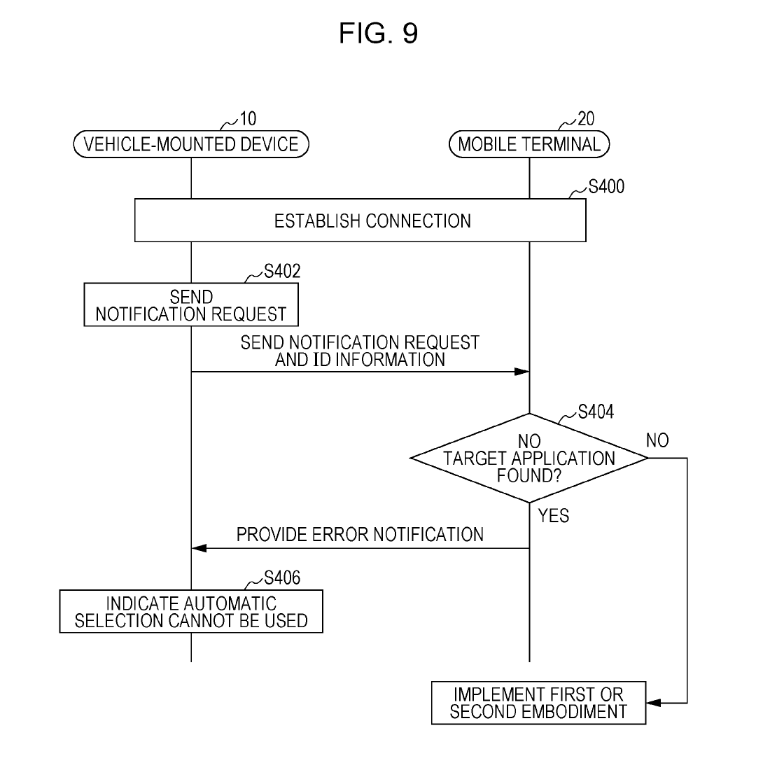

Next, yet further forms of the present disclosure are described. These forms relate to behavior occurring when an application corresponding to a request from the notification request section 220 is not stored in the mobile terminal 20. FIG. 9 is a flowchart that illustrates selecting the operation mode in the vehicle-mounted electronic system. These forms have a similar configuration to that in the first embodiment. S400 and S402 in FIG. 9 are substantially the same as S200 and S202 in FIG. 8, and they are not described here.

When the mobile terminal 20 receives a notification request and identification information for an application from the vehicle-mounted device 10, it determines whether such a target application is stored (S404). When the target application is not stored, the mobile terminal 20 transmits an error notification indicating the absence to the vehicle-mounted device 10. When the operation-mode selection section 250 in the vehicle-mounted device 10 receives the error notification, it causes the display section 160 to display an indication that the operation mode cannot be automatically switched (S406). In the example illustrated in FIGS. 7A and 7B, if only the icon 412 for the application PPP is displayed on the audio selecting screen 400, because the application PPP is not stored in the mobile terminal 20, the error notification is transmitted to the vehicle-mounted device. The user can recognize the absence of the application in the mobile terminal.

The preferred forms of the present disclosure are described above. The present invention is not limited to specific forms and can be modified and changed within the scope of the present invention described in the claims.

What is claimed is:

1. An electronic device comprising:
a connection unit configured to enable connection between the electronic device and an external device that stores one or more applications;
a selection unit configured to select at least one operation mode from among a plurality of operation modes;
an output unit configured to output information on the basis of the operation mode selected by the selection unit;
a request unit configured to request the external device to provide start-up notification for an application started in the external device, in response to connection by the connection unit;
a reception unit configured to receive the start-up notification through the connection unit; and
a control unit configured to control the selection unit so as to select an operation mode corresponding to the application identified by the start-up notification.

2. The electronic device according to claim 1, wherein the control unit includes a determination unit configured to determine whether switching of the operation mode is feasible, and wherein:
when the determination unit determines that the switching is feasible, the control unit is configured to cause the selection unit to change the operation mode, and
when the determination unit determines that the switching is unfeasible, the control unit is configured not to cause the selection unit to change the operation mode.

3. The electronic device according to claim 1, wherein the selection unit includes an input screen on which the plurality of operation modes is selectable, and one or more icons for starting up one or more applications stored in the external device are displayed on the input screen, and
wherein when an icon on the input screen is selected by a user, the selection unit is configured to select the operation mode corresponding to the application associated with the icon.

4. The electronic device according to claim 3, wherein when the control unit receives the start-up notification, the control unit is configured to cause the selection unit to automatically select the icon corresponding to the application identified by the start-up notification.

5. The electronic device according to claim 3, wherein the request unit is configured to provide the external device with identification information for the applications associated with the icons displayed on the input screen.

6. The electronic device according to claim 1, further comprising a unit configured to receive closing information indicating closing of the application started in the external device,
wherein the control unit is configured to control the selection unit so as to select a last operation mode.

7. The electronic device according to claim 2, wherein when the output unit outputs emergency information or interruption information, the determination unit is configured to determine that the switching of the operation mode is unfeasible.

8. The electronic device according to claim 7, wherein when the determination unit determines that the switching of the operation mode is unfeasible, the control unit is configured to display a user input screen that prompts a user to determine whether the operation mode is to be switched.

9. The electronic device according to claim 1, wherein the output unit is configured to receive video data or audio data created by the application started in the external device through the connection unit and is configured to output the received video data or the audio data.

10. The electronic device according to claim 1, wherein the electronic device is mounted on a movable vehicle, and the external device is a mobile terminal connected to the electronic device in the vehicle.

11. A system comprising:
an electronic device comprising:
a connection unit configured to enable connection between the electronic device and an external device that stores one or more applications;
a selection unit configured to select at least one operation mode from among a plurality of operation modes;
an output unit configured to output information on the basis of the operation mode selected by the selection unit;
a request unit configured to request the external device to provide start-up notification for an application started in the external device, in response to connection by the connection unit;
a reception unit configured to receive the start-up notification through the connection unit; and
a control unit configured to control the selection unit so as to select an operation mode corresponding to the application identified by the start-up notification; and
an external device connected to the electronic device through the connection unit, wherein the external device includes:
a storage unit configured to store one or more applications,
a user input unit,
an execution unit configured to execute an application in response to an instruction to start up the application received through the user input unit, and
a start-up notification providing unit configured to provide start-up notification for the application started by the execution unit in response to the request from the request unit.

12. The system according to claim 11, wherein the external device further includes a display unit configured to display one or more icons for starting up the one or more applications, and
wherein at least one icon displayed on the input screen in the electronic device is identical with at least one of the icons displayed by the display unit.

13. The system according to claim 11, wherein the external device further includes a transmission unit configured to transmit audio data or video data obtained by the execution of the application to the electronic device through the connection unit when the execution unit executes the application, and
wherein the output unit in the electronic device is configured to output the audio data or video data received through the connection unit.

14. The system according to claim 11, wherein the external device is further configured to provide the electronic device with closing information indicating closing of the started application when the started application is closed.

15. A non-transitory computer-readable storage medium storing an operation-mode selection program executable by an electronic device connectable to an external device that stores one or more applications, the operation-mode selection program configured to direct the electronic device to perform:
a step of detecting connection to the external device;
a step of requesting the external device to provide start-up notification for an application started in the external device;
a step of selecting an operation mode corresponding to an application identified by the received start-up notification; and
a step of executing the selected operation mode.

16. The non-transitory computer-readable storage medium according to claim 15, wherein in the step of requesting the external device to provide the start-up notification, identification information for an application that is able to be started in the electronic device is provided.

17. The non-transitory computer-readable storage medium according to claim 15, wherein the operation-mode selection program further comprises a determination step of determining whether switching to an operation mode corresponding to the application is feasible when the start-up notification is received,
wherein when it is determined in the determination step that the switching is feasible, the operation mode is switched.

18. The non-transitory computer-readable storage medium according to claim 15, wherein in the step of executing the operation mode, video data or audio data created by the application executed in the external device is received, and the received video data or audio data is output.

19. An operation-mode selection method for use in an electronic device connectable to an external device that stores one or more applications, the operation-mode selection method comprising:
a step of detecting connection to the external device;
a step of requesting the external device to provide start-up notification for an application started in the external device;
a step of selecting an operation mode corresponding to an application identified by the received start-up notification; and
a step of executing the selected operation mode.

20. The operation-mode selection method according to claim 19, wherein in the step of requesting the external device to provide the start-up notification, identification information for an application that is able to be started in the electronic device is provided.
